(19) United States
(12) Patent Application Publication
(10) Pub. No.: US 2011/0250567 A1
(43) Pub. Date: Oct. 13, 2011

(54) PROCESS FOR ORAL TISSUE PROTOTYPING

(75) Inventor: Uriel Yarovesky, Thousand Oaks, CA (US)

(73) Assignee: DENTAL ILLUSIONS, INC., Agoura Hills, CA (US)

(21) Appl. No.: 12/756,316

(22) Filed: Apr. 8, 2010

(51) Int. Cl. A61C 11/00; A61C 9/00

(52) U.S. Cl. 433/213; 433/214

(57) ABSTRACT

A process for oral tissue prototyping includes the steps of forming a prototype of an oral cavity and placing a sealer on an oral tissue area of the prototype. Thereafter, the sealer is painted with a tissue-colored paint and any other remaining details are added to the prototype to mimic the anatomical tissue coloration of the oral cavity.

### BACKGROUND OF THE INVENTION

The present invention generally relates a process for oral tissue prototyping. More particularly, the invention relates to replicating the anatomical coloration of tissue and mucosal tissue in oral cavity prototypes.

Dental molds are generally made from plaster or wax and are designed to provide an accurate three-dimensional representation of a patient's oral cavity. Dental molds are made from dental impressions that basically form a “negative” of the teeth and gums of a patient. Impressions are taken by placing a semi-viscous liquid disposed within a customized tray along the dentition of a patient. The viscous liquid then solidifies and becomes an elastic solid that can be removed from the mouth while retaining the shape of the teeth of the patient. Then, a viscous plaster wax is poured into the impression to create a three-dimension dental mold representing the oral cavity of the patient. The resulting dental mold is usually all one color when finalized. For example, the dental mold may be white (plaster) or a variety of other colors (wax). Hence, these dental molds do not accurately represent the coloration of the oral cavity.

With specific reference to tissue and mucosal tissue coloration, the current trend is for dentists to apply an additional layer of wax in tissue areas. The wax is used to simulate or mimic tissue coloration in those areas. Adding additional layers, in the form of wax, to the tissue areas of the dental mold alters the original contour of the tissue. The added thickness also alters the visual appearance of the dental mold and consequently inhibits the accurate and life-like representation of the oral cavity. The wax also includes excessive flash that must be trimmed around the exterior contour of the dental mold. Without cutting the excess flash, the accuracy of the dental mold is especially sacrificed. Cutting the flash is also labor intensive to the dentist. There are currently no other methods or apparatuses known in the art capable of preparing a dental mold to accurately mimic the natural oral cavity coloration.

There exists, therefore, a significant need in the art for a process for prototyping oral tissue to accurately represent the visual appearance of an oral cavity on a dental mold. Such a process should include the steps of taking a dental impression, painting the oral tissue areas of the dental impression with colors representing the oral cavity and detailing these oral tissue areas to accurately represent veins and other microstructures of the oral cavity. The present invention fulfills these needs and provides further related advantages.

### SUMMARY OF THE INVENTION

The process for oral tissue prototyping of the present invention includes the steps of forming a prototype of an oral cavity from an oral cavity impression of a patient. A sealer is then applied to an oral tissue area of the prototype that includes a mucosal tissue area, a concavity tissue area, a palate tissue area or a gum tissue area. The sealer is then painted over with a tissue-colored paint such as low chroma pink. Moreover, the prototype is further detailed to mimic the anatomical tissue coloration of the oral cavity by applying a vein or oral cavity microstructure to the oral cavity area, highlighting an elevated zone of the oral tissue area, or emphasizing subtle coloration changes in the oral tissue area with a second tissue-colored paint. Finally, the oral tissue area is cured with a light glaze.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a flowchart illustrating the steps for prototyping oral tissue in accordance with the present invention;

FIG. 2 is a perspective view of a dental mold in accordance with the present invention;

FIG. 3 is a perspective view of the dental mold of FIG. 1, illustrating separation of an upper jaw and a lower jaw;

FIG. 4 is a perspective view of the upper jaw, illustrating painting a tissue area of the dental mold;

FIG. 5 is another perspective view of the dental mold in accordance with the present invention, illustrating veins detailed into the tissue area;

FIG. 6 is a perspective view of the dental mold, illustrating fully painted tissue areas of the oral cavity;

FIG. 7 is an alternative view of the dental mold of FIG. 6;

FIG. 8 is a top view of a non-painted palate; and

FIG. 9 is a top view of the palate of FIG. 7 after being painted in accordance with the present invention.

### DETAILED DESCRIPTION OF THE PREFERRED EMBODIMENT

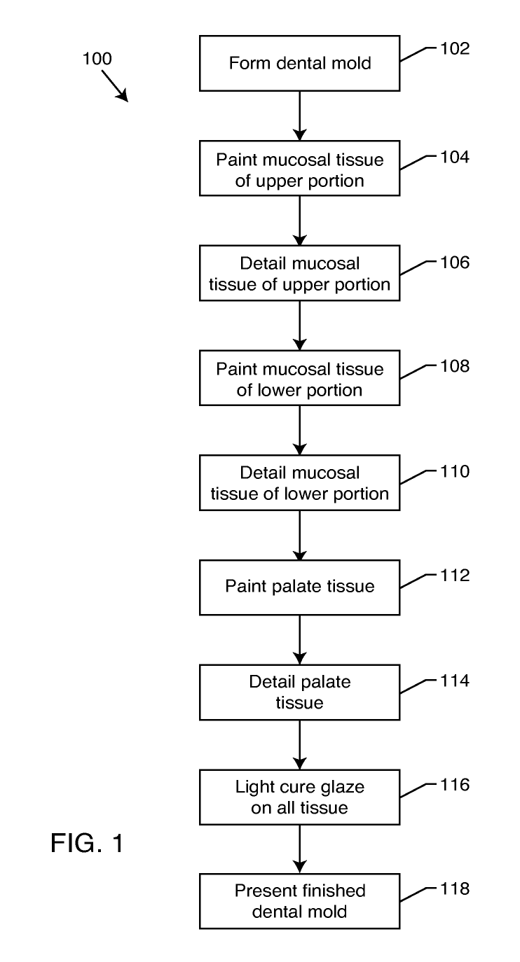

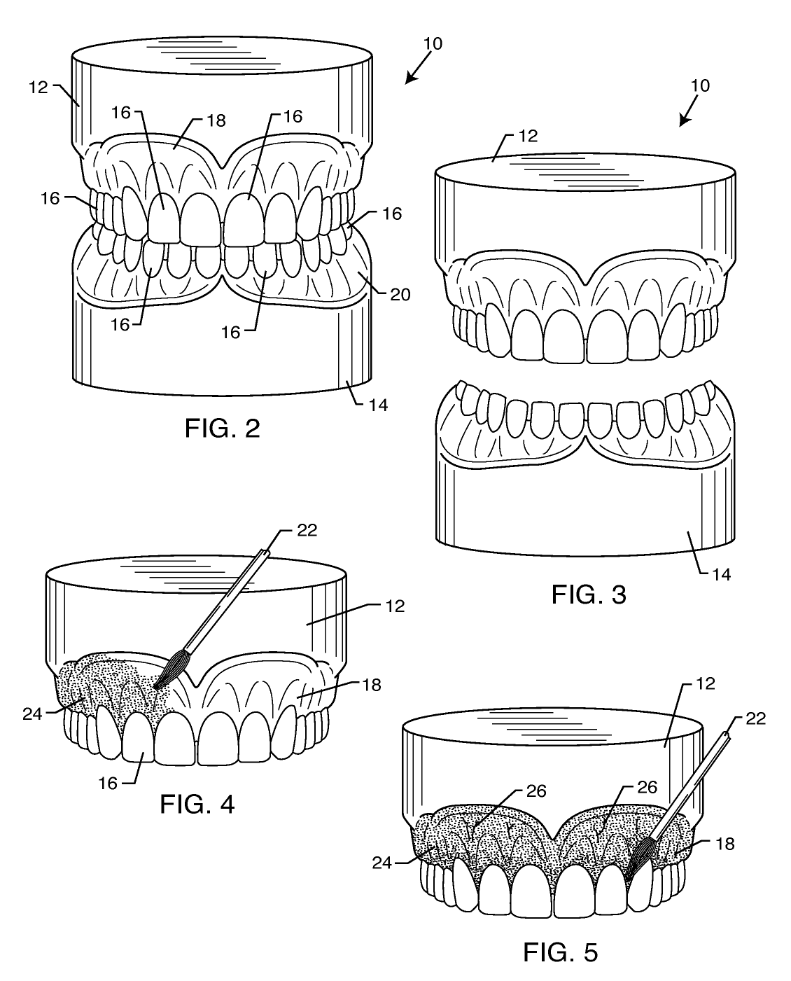

As shown in the drawings for purposes of illustration, the present invention for a process of prototyping oral tissue is referred to generally by the reference number 100. Turning now to FIG. 1, the process for prototyping oral tissue (100) begins by forming a dental mold (102). A sample dental mold 10 is illustrated in FIG. 2. The dental mold 10 generally comprises an upper portion 12 and a lower portion 14. The dental mold 10 may comprise stone, wax or plaster. Both portions 12, 14 have a plurality of teeth 16 formed therein. The upper portion 12 also includes an upper tissue area 18 and the lower portion 14 includes a lower tissue portion 20. The dental mold 10 is formed by taking an impression of the oral cavity of a patient. The impression is filled with a plaster or wax material that later solidifies to replicate the oral cavity of the patient. As shown in FIG. 3, the upper portion 12 and the lower portion 14 may be separated into two separate sections.

The next step in the present invention is to paint the mucosal tissue of the upper tissue (104). The purpose of painting the mucosal tissue is to better characterize the dental mold 10 as a replica of the anatomical oral cavity. Accordingly, a dentist or lab technician uses a paint brush 22 to apply a layer of paint 24 to the upper tissue portion 18 as depicted in FIG. 4. Preferably, the layer of paint 24 comprises a low chroma pink color or other reddish to pinkish color that is anatomically similar to an actual oral cavity. The layer of paint 24 should also highlight elevated zones and emphasize subtle tissue color changes. Next, the dentist or dental technician should detail the mucosal tissue of the upper tissue (106). FIG. 5 illustrates a plurality of veins 26 detailed into the upper tissue portion 18. Other oral cavity microstructures may be added during this detailing step (106) to the mucosal tissue area or concavity areas of the dental mold 10. FIG. 5 also shows the upper tissue portion 18 completely covered by the layer of paint 24.

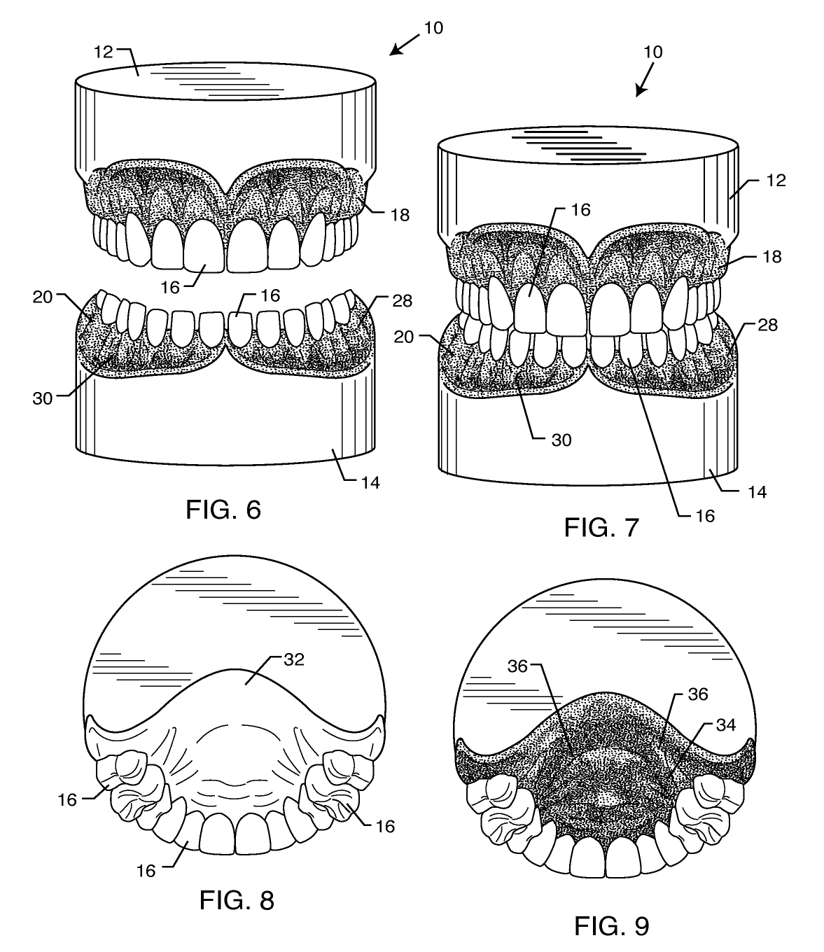

As shown in FIG. 1, the next step of the process of the present invention is to paint mucosal tissue of the lower portion (108) and detail the mucosal tissue of a lower portion (110). Accordingly, FIGS. 6 and 7 illustrate the dental mold 10 having an additional layer of paint 28 and an additional set of veins 30 applied to the lower tissue portion 20. The layer of paint 28 should mimic the tissue coloration of the oral cavity in a similar manner, as described above, as the layer of paint 24 applied to the upper portion 12. Likewise, other oral cavity microstructures may be added to the lower tissue portion 20 during the second detailing step (110). Accordingly, the layers of paint 24, 28 are applied over the entire tissue portions 18, 20 and between the plurality of teeth 16 in the upper portion 12 and the lower portion 14. Likewise, both the upper portion 12 and the lower portion 14 each contain the set of veins 26, 30.

The flowchart in FIG. 1 further illustrates the step of painting the palate tissue (112) and detailing the palate tissue (114). FIG. 8 illustrates a palate 32 disposed behind the plurality of teeth 16. The palate 32 is painted (114) with a layer of palate paint 34 as shown in FIG. 9. In the detailing the palate tissue step (114) of FIG. 1, a plurality of oral cavity details 36 (FIG. 9) may be added to the layer of palate paint 34. Thereafter, the dentist or dental technician light cures a glaze on the painted tissue areas (116). Accordingly, the finished dental mold is then presented to the patient (118).

The main endeavor of the present invention is to mimic the natural colors and characterization thereof in an oral cavity prototype for future planning. Patients will be able to better identify with dental mold replicas having tissue details that are similar to natural anatomical oral cavity coloration. Such coloration enables a dentist or lab technician to present to a patient an extremely realistic prototype of the oral cavity of the patient. The present invention is particularly advantageous, as the prior art dental molds are primarily one color and are, therefore, unrealistic. A colorful dental mold permits the dentist to present to the patient a more realistic view of the changes to be achieved in the oral cavity of the patient.

Moreover, dentists on the speaking circuit or those who use dental molds in presentations will find the present invention particularly useful. Now dentists will have the opportunity to present a realistic dental mold in lectures in such a way that audiences will have a new appreciation of the influence of tissue color and contour regarding the aesthetic considerations of the patient. In turn, dental restoration and orthodontic procedures will preferably be held to a higher standard such that the fields of dentistry and orthodontics will achieve better perfection and patient care in the long term.

Although a preferred embodiment as been described in detail for purposes of illustration, various modifications may be made without departing from the scope and spirit of the invention. Accordingly, the invention is not to be limited, except as by the appended claims.

What is claimed is:

1. A process for oral tissue prototyping, comprising the steps of:
forming a prototype of an oral cavity;
placing a sealer on an oral tissue area of the prototype;
painting over the sealer with a tissue-colored paint; and
detailing the prototype to mimic the anatomical tissue coloration of the oral cavity.

2. The process of claim 1, wherein the detailing step includes the step of applying a vein or an oral cavity microstructure to the oral tissue area.

3. The process of claim 1, wherein the oral tissue area comprises a mucosal tissue area, a concavity tissue area, a palate tissue area or a gum tissue area.

4. The process of claim 1, including the step of highlighting an elevated zone of the oral tissue area.

5. The process of claim 1, including the step of emphasizing subtle coloration changes in the oral tissue area with a second tissue-colored paint.

6. The process of claim 1, including the step of light curing a glaze over the oral tissue area.

7. The process of claim 1, wherein the tissue-colored paint comprises low chroma pink.

8. The process of claim 1, wherein the forming step includes the step of taking an oral cavity impression of a patient.

9. A process for oral tissue prototyping, comprising the steps of:
forming a prototype of an oral cavity from an oral cavity impression of a patient;
placing a sealer on an oral tissue area of the prototype;
painting over the sealer with a tissue-colored paint;
detailing the prototype to mimic the anatomical tissue coloration of the oral cavity; and
light curing a glaze over the tissue area.

10. The process of claim 9, wherein the detailing step includes the step of applying a vein or an oral cavity microstructure to the oral tissue area.

11. The process of claim 9, wherein the oral tissue area comprises a mucosal tissue area, a concavity tissue area, a palate tissue area or a gum tissue area.

12. The process of claim 9, including the step of highlighting an elevated zone of the oral tissue area.

13. The process of claim 9, including the step of emphasizing subtle coloration changes in the oral tissue area with a second tissue-colored paint.

14. The process of claim 9, wherein the tissue-colored paint comprises low chroma pink.

15. A process for oral tissue prototyping, comprising the steps of:
forming a prototype of an oral cavity;
placing a sealer on an oral tissue area of the prototype;
painting over the sealer with a tissue-colored paint;
detailing the prototype to mimic the anatomical tissue coloration of the oral cavity;
applying a vein or an oral cavity microstructure to the oral tissue area; and
light curing a glaze over the oral tissue area.

16. The process of claim 15, wherein the oral tissue area comprises a mucosal tissue area, a concavity tissue area, a palate tissue area or a gum tissue area.

17. The process of claim 16, including the steps of highlighting an elevated zone of the oral tissue area and emphasizing subtle coloration changes in the oral tissue area with a second tissue colored paint.

18. The process of claim 17, wherein the tissue-colored paint comprises low chroma pink.

19. The process of claim 17, wherein the forming step includes the step of taking an oral cavity impression of a patient.
